(19) United States
(12) Patent Application Publication
(10) Pub. No.: US 2013/0108790 A1
(43) Pub. Date: May 2, 2013

(54) LIFTING SUBSTRATE WITH AIR CUSHION WHILE PRINTING

(71) Applicants: Soenke Dehn, Scharnhagen (DE); Detlef Schulze-Hagenest, Molfsee (DE)

(72) Inventors: Soenke Dehn, Scharnhagen (DE); Detlef Schulze-Hagenest, Molfsee (DE)

(21) Appl. No.: 13/660,278

(22) Filed: Oct. 25, 2012

(30) Foreign Application Priority Data
Oct. 31, 2011 (DE) 10 2011 117 494.3

(51) Int. Cl. B05C 13/00; B05D 1/26

(52) U.S. Cl. 427/256; 118/500

(57) ABSTRACT

A device for printing a substrate web moved in a direction of transport past a printing unit includes a substrate web lifting device arranged opposite the at least one printing unit. The lifting device has a jacket surface opposite the printing unit. An air cushion unit forms an air cushion between the substrate web and the jacket surface of the substrate web lifting device, so that lifting of the substrate web is achieved. Printing can be accomplished by guiding the substrate web over the jacket surface. A region of the substrate web is lifted in a printing region by developing an air cushion between the substrate web and the jacket surface of the substrate web lifting device. The lifted region of the substrate web is printed.

### CROSS-REFERENCE TO RELATED APPLICATIONS

The present application claims priority of German Application Number 102011117494.3, filed Oct. 31, 2011, by Dehn et al.

This application has related subject matter to U.S. patent application Ser. No. ______, (Attorney Docket Number K000229US02), titled “SUBSTRATE WEB SUCTION FOR PRINTING,” by Dehn et al., filed herewith.

### FIELD OF THE INVENTION

The present invention relates to a device and a method for printing web-shaped substrates, in particular substrate webs in a printing press with inkjet printing heads.

### BACKGROUND OF THE INVENTION

Transport means for substrate webs which transport a substrate web past a printing unit with the aid of a drum are known in printing technology. With such devices, a high surface precision of the drum is necessary, since any imprecisions occurring in the drum surface would lead to a varying distance between the drum and the printing unit. Imprecisions of this type could lead to a deterioration in the printed image upon printing of the substrate web.

Furthermore, with the aforementioned drums it is possible that the substrate web is not in contact with the drum in a defined manner over its entire width.

### SUMMARY OF THE INVENTION

According to an aspect of the present invention, there is provided a device for printing a substrate web that is moved in a direction of transport past at least one printing unit, the device comprising a substrate web lifting device arranged opposite the at least one printing unit, the lifting device having:

a jacket surface opposite the printing unit; and

air cushion means forming an air cushion between the substrate web and the jacket surface of the substrate web lifting device, so that lifting of the substrate web is achieved.

According to another aspect of the present invention, there is provided a method for printing a substrate web that is moved in a direction of transport past at least one printing unit, the method comprising:

guiding the substrate web over a jacket surface of a substrate web lifting device arranged opposite the printing unit;

lifting a region of the substrate web in a printing region by developing an air cushion between the substrate web and the jacket surface of the substrate web lifting device; and

printing the lifted region of the substrate web.

There is provided a device and a method for transporting a web-shaped substrate in the region of a printing head, in particular an inkjet printing head, with which a defined distance can be maintained between a substrate web and an inkjet printing head over an entire width of the substrate web.

In various aspects, a device is provided for printing a substrate web that is moved in a direction of transport past at least one printing unit. The device has a substrate web lifting device which is arranged opposite the at least one printing unit and which has a jacket surface opposite the printing unit and air cushion means forming an air cushion between the substrate web and the jacket surface of the substrate web lifting device such that lifting of the substrate web is achieved.

With a device of this type, it can be assured that the substrate web is transported past the printing units at a constant distance from them. In addition, with an arrangement of this type an at least partial drying of the substrate web can be achieved in the course of printing the substrate web. It should also be noted that the usual transport means for substrate webs should have a high surface precision, as otherwise a defined distance cannot be maintained over the entire width of a substrate web in the region of the printing units. Various aspects are advantageous in this respect too, since the blowing of air against the substrate web enables a precisely defined distance from the printing units to be maintained, irrespective of the surface precision of a substrate web transport means.

In accordance with one aspect, a rotation of the substrate web lifting device can promote the development of an air cushion between the jacket surface of the substrate web lifting device and the substrate web. The air cushion means can here be formed by at least one groove structure, in particular by a spiral groove structure, in the jacket surface. A groove structure of this type in the substrate guiding surface permits an improved and more uniform distribution of air between the substrate web lifting device and a substrate web guided over it. This allows a reduction in the quantity of energy required for the rotation of the substrate web lifting device to achieve a sufficient air cushion. This can also result in a lower noise emission. In edge regions of the substrate web in particular, the groove structure can provide a controlled air flow, by which any fluttering of the substrate web and an associated noise generation can be reduced.

In accordance with a further aspect, the substrate web lifting device is a pipe with an interior, where the air cushion means can have at least one fan, in particular a radial compressor, which is arranged inside the pipe and is rotatably connected to the pipe. With this aspect, the substrate web lifting device would also have gas outflow openings that extend from the interior to the jacket surface of the substrate web lifting device and through which air aspirated by the fan/radial compressor is discharged to promote the development of the air cushion between the substrate web and the jacket surface still further. An arrangement of this type does not require any additional blower device to generate blown air/compressed air and thus represents an inexpensive solution.

In a further aspect, the air cushion means in the interior can have at least two fan wheels which are arranged on opposite ends of the pipe. These can generate a higher back pressure in the interior of the pipe, by which an improvement in the air cushion can be achieved.

At least one air baffle plate can be arranged adjacent to the substrate web lifting device so that a gas stream flowing out of the gas outflow openings reaches the region between the jacket surface of the substrate web lifting device and the substrate web. This can lead to an improvement in the air cushion, since without such an air baffle plate air flowing out of the gas outflow openings and which flows out of a region of the substrate web lifting device which is not enveloped by the substrate web would be unused. The air baffle plate here guides the air stream in a region formed between the incoming substrate web and the substrate web lifting device.

In one aspect, at least one displacement unit is provided in the interior of the pipe to displace at least one fan wheel, in order to enable a selective application of air to gas outflow openings via the interior. This makes it possible for gas to be substantially applied to only those gas outflow openings that are covered by a substrate web during operation, in order to reduce leakage flows. It is thus possible to adapt to substrate webs of different widths. This allows a reduction in the entire air quantity and in an associated energy consumption, and possibly also in noise generation.

According to various aspects, the channel structure inside the jacket surface has a plurality of spaced circumferential channels extending in the circumferential direction of the round jacket surface and at least one transverse channel extending transversely to said circumferential channels, which is in a flow connection to at least two circumferential channels. This permits a good distribution of air between the substrate web lifting device and the substrate web. The at least one transverse channel can here extend in the circumferential direction of the circumferential channels centrally thereto. The circumferential channels are preferably at the same distance relative to one another. However, a different arrangement of the circumferential channels can also be provided. With an arrangement of this type for the circumferential channels and for the at least one transverse channel, supplied gas/air can be readily distributed into the respective channels, so that a uniform air cushion can be achieved between the substrate web lifting device and the substrate web.

In one aspect, at least some of the gas outflow openings open towards at least one transverse channel in order to enable good distribution of the supplied gas over a width of a substrate web.

In an alternative aspect, the channel structure has a statistical distribution in the jacket surface. This permits a particularly uniform distribution of supplied gas over the jacket surface.

The jacket surface can have a plurality of separate channel structure segments that are arranged adjacent to each other over a width of the jacket surface, where a corresponding channel structure is in flow connection to at least one gas outflow opening. The individual channel structure segments can be separated from one another by regions without channels of the jacket surface. The channel structure segments are preferably therefore not in flow connection to one another via channels. An arrangement of this type of channel structure segments enables, in particular with a segmental application to the gas outflow openings, a good adaptation to the width of a web-shaped substrate. The separation of the channel structure segments enables leakage flows to be reduced over the respective channel structure. Gas inflow opening(s) associated with a respective channel structure segment can preferably be supplied with gas in groups.

In one aspect, the interior that is in flow connection to the gas outflow openings and which can be supplied with gas is subdivided in order to permit ready implementation of individual or grouped controllability of the gas outflow openings. A slide valve can also be arranged inside the interior such that it enables a selective application of gas to gas outflow openings with gas via the interior. A slide valve of this type permits a continuous adjustment of the region of the interior via which gas outflow openings can be supplied with gas. This makes possible an almost continuous adjustment to the width of a substrate web. Two slide valves may be provided which are displaceable from opposite ends into the interior in order to permit adaptation to the length and width of the substrate web.

Alternatively, or even additionally, a plurality of valves can be provided for the individual or grouped application of gas to gas outflow openings.

Furthermore, a device is provided for printing a substrate web, the device having a substrate web suction device arranged opposite the at least one printing unit. The substrate web suction device has gas inflow openings arranged on a jacket surface of the substrate web suction device opposite the printing unit. Furthermore, the device has an underpressure device that sucks in air through the gas inflow openings to achieve suction of the substrate web onto the substrate web suction device. The use of such a device enables a defined distance to be readily maintained between the substrate web and the printing unit over the entire width of the substrate web.

In an alternative aspect of the device, the substrate web lifting device is designed as a rotatable pipe with an interior, said interior being connected to the jacket surface via the gas inflow openings. The blower is here arranged in the interior, and air is aspirated via the interior and via the gas inflow openings into the jacket surface by rotation of the substrate web lifting device. An arrangement of this type does not require an additional suction device to generate underpressure and is therefore an inexpensive solution.

### BRIEF DESCRIPTION OF THE DRAWINGS

Various aspects are described below in more detail with reference to the drawings, which show in:

FIG. 1 is a schematic side view of a printing press with a substrate web lifting device;

FIG. 2 is a schematic sectional view of a substrate web lifting device, which is rotated in a specific direction;

FIG. 3 is a schematic plan view of a substrate web lifting device in accordance with a first aspect;

FIG. 4 is a schematic side view of a substrate web lifting device in accordance with a second aspect;

FIG. 5 is a schematic sectional view through the substrate web lifting device in accordance with FIG. 4 along the line 5-5;

FIG. 6 is a schematic sectional view similar to that in FIG. 5 with an alternative aspect of the substrate web lifting device;

FIG. 7 is a schematic plan view of a substrate web lifting device;

FIG. 8 is a schematic plan view of an alternative substrate web lifting device;

FIG. 9 is a schematic detailed view of a channel structure in a surface of a substrate web lifting device in accordance with various aspects;

FIG. 10 is a schematic sectional view through the substrate web lifting device in accordance with FIG. 9 along the line 10-10 in FIG. 9; and

FIG. 11 is a schematic detailed view of a channel structure in a surface of a substrate web lifting device in accordance with various aspects.

In the following description, the position/direction information relates primarily to the representations in the drawings and should therefore not be regarded as restrictive. They can however also relate to a preferred final arrangement. The same reference numbers are substantially used throughout for the drawings in so far as identical or equivalent elements are described. The attached drawings are for purposes of illustration and are not necessarily to scale.

### DETAILED DESCRIPTION OF THE INVENTION

The following describes devices and methods in which air is expelled from the substrate web lifting device, thereby generating an air cushion between the substrate web and the substrate web lifting device. In various aspects, these devices and methods are also applicable to devices and methods in which the air is sucked into a substrate web suction device, which substantially corresponds in structure to the substrate web lifting device, thereby generating a negative pressure between the substrate web and the substrate web suction device, which in turn leads to a suction of the substrate web onto the substrate web suction device.

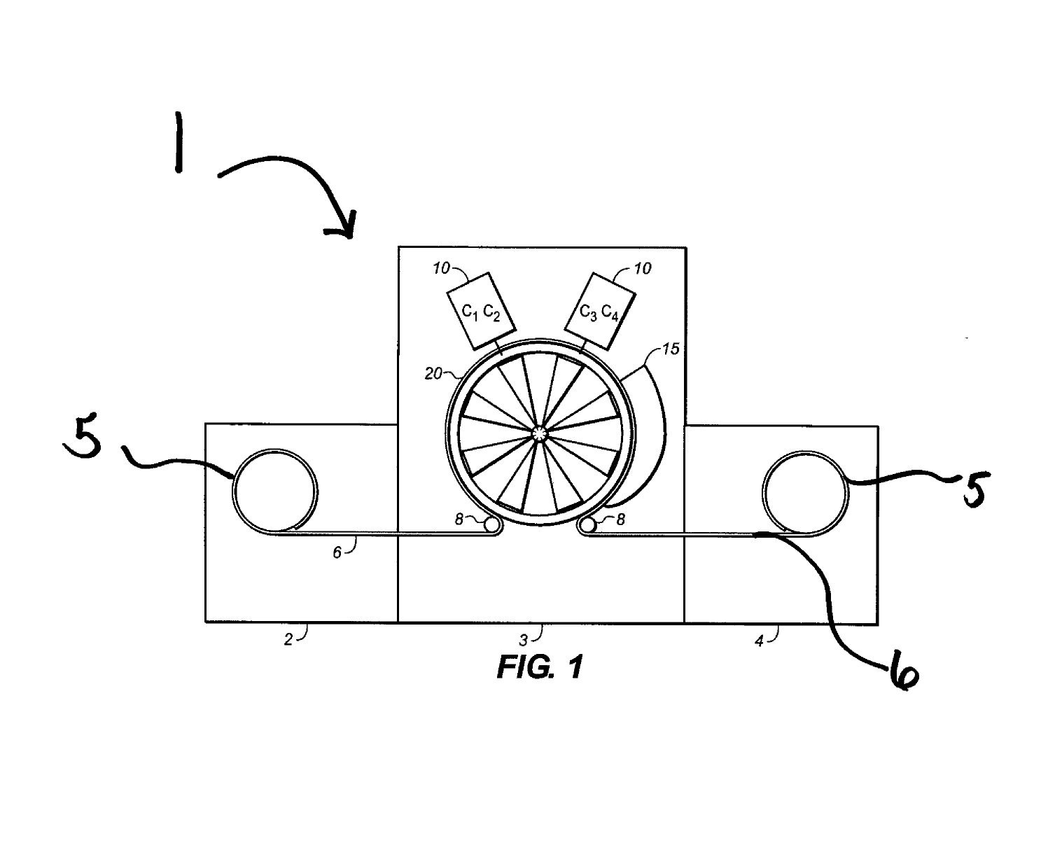

FIG. 1 shows a schematic side view of a printing press 1 with a feeder region 2, a printing region 3 and a stacker region 4.

A substrate roll 5 is provided in the feeder region 2 from which a substrate web 6 is fed to the printing region 3 for printing. A substrate roll 5 is provided in the stacker region 4 to accommodate a substrate web 6 coming from the printing region 3.

A plurality of rolls 8 is provided in the printing region 3 to guide the substrate web 6, as well as a plurality of printing units 10. Two of the rolls 8 are shown schematically in FIG. 1, although a greater number is provided as a rule to transport the substrate web 6 along a non-linear transport path through the printing region 3. The left-hand one of the two rolls 8 is arranged such that it deflects the substrate web 6 in a lower region towards a substrate web lifting device 20, such that the substrate web 6 is pressed against the substrate web lifting device 20. The substrate web lifting device 20, which is described in more detail below, brings about a controlled lifting of the substrate web in the printing region 3 during a printing process, during which the substrate web 6 is printed. The right-hand one of the two rolls 8 is here arranged such that the substrate web 6 is deflected by this roll 8 such that substrate web 6 can encircle the substrate web lifting device 20 over a range of more than 300°, as shown schematically in FIG. 1. In the further course of the description, alternative aspects are described in which an encircling of the substrate web lifting device 20 by the substrate web 6 occurs in an angle range that is markedly lower, preferably in the range of 90° to 180°.

Two printing units 10, each for two colors (“C₁C₂” and “C₃C₄”), are shown in FIG. 1 so that the printing press 1 in accordance with FIG. 1 would be suitable for four-color printing. However, a different number of printing units 10 can be provided. The printing units 10 are preferably inkjet printing units, but can also be of another digital type. A dryer 15 is further shown in FIG. 1.

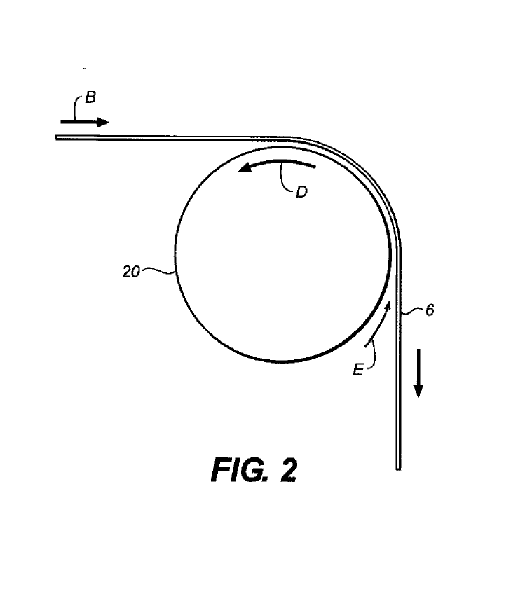

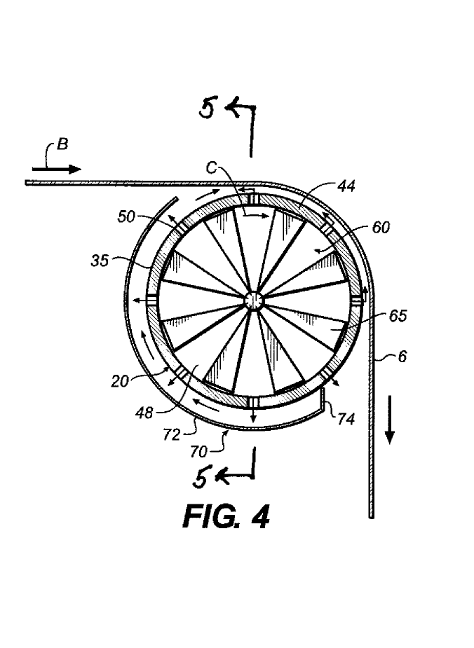

The substrate web lifting device 20 is, in accordance with a aspect, coupled to a rotary drive, not shown, that can rotate the substrate web lifting device 20, for example in the direction shown by arrow C in FIG. 4. The rotation can be substantially in the direction of movement of the substrate web, as shown by the arrow C in FIG. 4, or substantially in the opposite direction, as indicated by the arrow D in FIG. 2. A rotation of the substrate web lifting device 20 sucks air into the encircling region between the substrate web lifting device 20 and the substrate web 6 in order to create an air cushion between them, as indicated by the arrow E in FIG. 2. It is an advantage in both cases if the speed of rotation of the substrate web lifting device 20 is substantially greater than the transport speed of the substrate web 6.

The substrate web lifting device 20 can have the same basic structure in all cases, so that only different aspects of the substrate web lifting device 20 are described in more detail below.

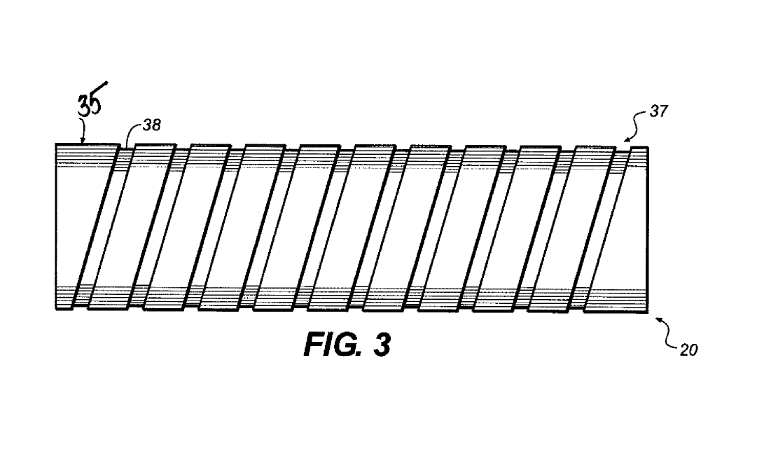

FIG. 3 shows a schematic plan view of a substrate web lifting device 20 in accordance with a first aspect. With this aspect, the substrate web lifting device 20 is designed as a rod or a hollow pipe with a jacket surface 35. A groove structure 37 is formed in the outer jacket surface 35 (see FIG. 4) and as shown has a circumferential spiral groove 38. This spiral groove 38 promotes, during rotation of the substrate web lifting device 20, the suction and distribution of air to form an air cushion E between the substrate web lifting device 20 and the substrate web 6. Although a continuous spiral groove 38 is shown as the groove structure in FIG. 3, it should be noted that other groove structures are conceivable, in particular comprising a plurality of different individual grooves which may be completely separate, but which may also intersect. In particular, for example, opposing-direction spiral grooves are conceivable which extend from the ends of the substrate web lifting device to a central region thereof. Transverse grooves, i.e., grooves extending transversely to the direction of rotation of the substrate web lifting device 20, can promote the suction and distribution of air between the substrate web lifting device 20 and the substrate web 6.

Further aspects of the substrate web lifting device 20 are discussed in more detail below with reference to FIGS. 4 to 6.

FIG. 4 shows a schematic sectional view through the substrate web lifting device 20 in accordance with an alternative aspect. In the sectional view, it can be seen how the substrate web 6 is guided around the substrate web lifting device 20, although only the actual sectional plane through the substrate web lifting device 20 is shown in order to simplify representation. The substrate web lifting device 20 in this aspect is designed as a hollow pipe and has a pipe body 44 having an outer jacket surface 35 and an interior 48 inside it. Gas outflow openings 50 are provided in the pipe body 44 which enable an air flow from the interior 48 to the jacket surface 35. The jacket surface 35 can be designed substantially smooth, as shown, or can have a structure such as a groove structure 37 as described above for the first aspect. In this case, the gas outflow openings 50 can be arranged such that they open into the groove structure 37.

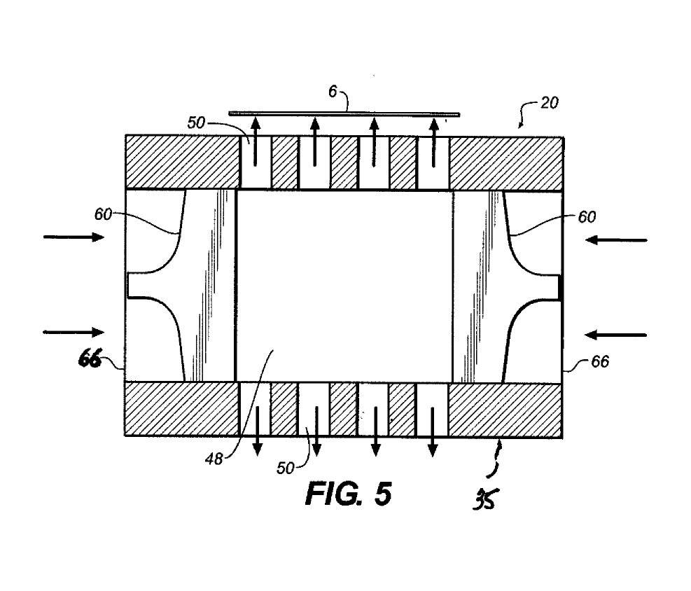

Two fans 60 with lamellae or wings 65 are arranged in the interior 48, as can be seen in the schematic sectional view in accordance with FIG. 5. Only one of the fans is discernable in FIG. 4. Axial fans are provided for the aspect shown. The fans 60 can however also be designed as radial compressors, which suck in air in the axial direction and deflect it in the radial direction and compress it, or as axial fans, as described above, which suck in the air axially and transport it in the axial direction. With the use of radial compressors, these should preferably be aligned with the gas flow openings 50 in the pipe body 44.

The fans 60 are connected non-rotatably to the substrate web lifting device 20, so that upon a rotation of the substrate web lifting device 20 they also rotate and thereby transport air into the interior 48 and in particular to the gas flow openings 50 in the pipe body 44. The fans 60 operate in opposite directions, so that with a corresponding rotation of the substrate web lifting device 20 air is aspirated via axial end openings 66 into the interior 48 and transported to the center of the interior.

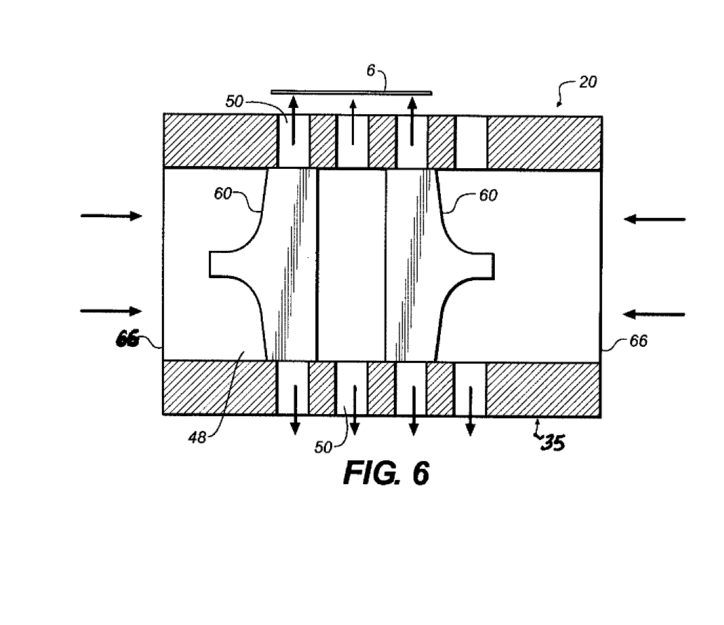

FIG. 6 shows the fans 60 in a displaced position, in which only certain gas flow openings 50 are supplied with air by the fans 60. The fans can be fixed in the axial direction of the interior 48 or can be displaceable in the axial direction, to enable a selective application of air to the gas flow openings 50 via the fans 60. In this manner, it is for example possible to supply air only to those gas flow openings 50 that are in the region of the substrate web 6.

In various aspects, instead of two fans 60, it is also possible to provide just one fan 60 and to close off an axial end opening of the interior 48 by means of a corresponding wall element.

In various aspects, air baffle plate 70 (shown in FIG. 4), which is not shown in the sectional representations of FIGS. 5 and 6, is provided adjacent to the jacket surface 35 of the substrate web lifting device 20. The air baffle plate 70 has a main part 72 following the contour of the jacket surface 35 over a circumferential region thereof, and a part 74 at an angle thereto and extending to the substrate web lifting device 20. The air baffle plate 70 is arranged adjacent to a region of the jacket surface 35 of the substrate web lifting device 20 which is not encircled by the substrate 6 in operation.

Referring to FIG. 4, the main part 72 is arranged such that a substantially uniform annular gap section is formed between the main part 72 and the jacket surface 35 and is limited in the circumferential direction at one end by the angled part 74. At the other end, the annular gap section is open, with the opening facing the region in which the substrate is guided around the substrate web lifting device 20. Air that exits the substrate web lifting device 20 in the region of the annular gap section is thus routed in a targeted manner to the encircling region between the substrate web 6 and the substrate web lifting device 20, in the circumferential direction corresponding to the direction of rotation C of the substrate web lifting device 20. In the representation in FIG. 4, the direction of movement B of the substrate 6 and the direction of rotation C of the substrate web lifting device 20 are substantially aligned. It is however also possible, as mentioned above, for the substrate web lifting device 20 to rotate counter to the direction of movement B of the substrate web 6, with the air baffle plate 70 then having to be adapted accordingly.

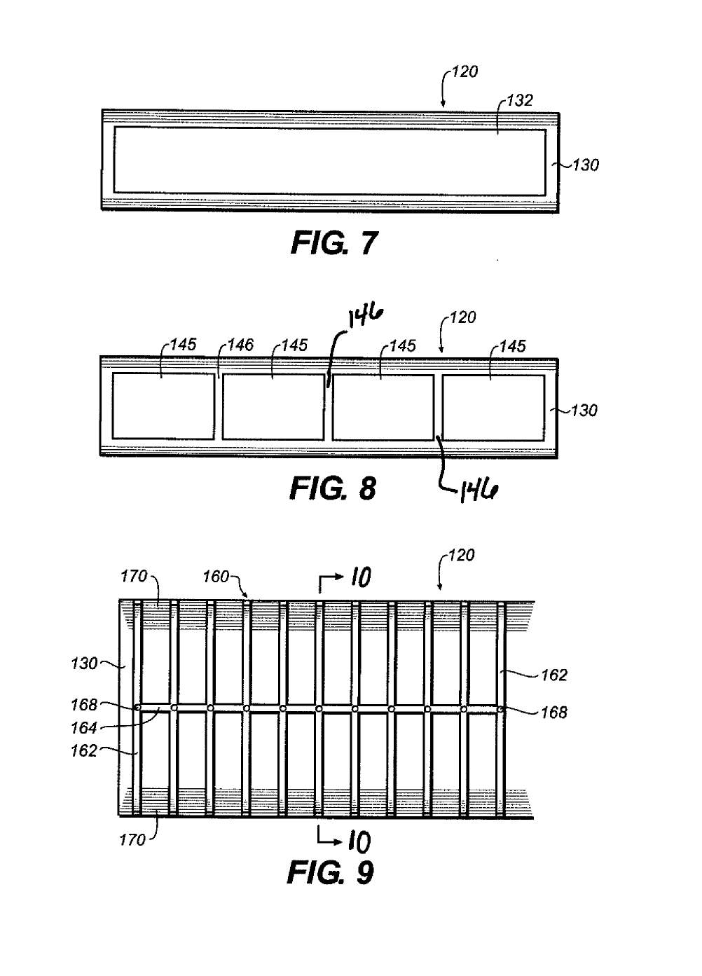

FIG. 7 shows a schematic plan view of a further aspect of a pipe-shaped substrate web lifting device 120. That region of the substrate web lifting device 120 that is encircled by the substrate web 6 during operation of said substrate web lifting device 120 can be seen in particular in the plan view. The substrate web lifting device 120 has in this region a surface referred to below as the jacket surface 130. The jacket surface has a region 132 in which a continuous channel structure is formed, the structure of which is described further below. The region 132 extends over approximately the entire width of the substrate web lifting device 120. The region 132, and hence the channel structure formed therein, extends in the circumferential direction over approximately 180° of the substrate web lifting device 120. It can preferably extend over more than 180° in the circumferential direction of the substrate web lifting device 120, depending on the arrangement of the printing units 10.

FIG. 8 shows a schematic plan view of a stationary, i.e. non-rotatable, pipe-shaped substrate web lifting device 120 in accordance with an alternative aspect. The region of the substrate web lifting device 120 which is encircled by the substrate web 6 during operation of said substrate web lifting device 120, can be seen here again in the plan view. The substrate web lifting device 120 here again has a surface that is referred to below as the jacket surface 130. Continuous channel structures are formed in regions 145, the structure of which is described further below. The regions 145 are arranged adjacent to one another over the width. Within the respective regions 145, the channel structures are continuous, i.e. all regions 145 of the channel structure are interconnected via corresponding channels thereof. In contrast, there is no connection to the channel structures of adjacent regions 145. To do so, regions 146 are provided, each of which is a region of the jacket surface 130 without channels. The jacket surface 130 thus has a plurality of segments or regions 145 with channel structures formed therein and regions 146 lying between them without such channel structures. The regions 145 are arranged adjacent to each other over approximately the entire width of the substrate web lifting device 120. The regions 145, and hence the channel structures formed therein, extend in the circumferential direction over approximately 180° of the substrate web lifting device 120. They should preferably extend far enough over the substrate web lifting device 120 that the substrate web 6 is guided by the channel structure in the region that faces the printing units 10, so that a controlled lifting of the substrate web 6 can be assured throughout the entire printing process.

FIG. 9 shows a schematic detailed view of a continuous channel structure 160 in a jacket surface 130 of a substrate web lifting device 120 in accordance with a first aspect. The channel structure 160 in the form shown can be provided in the jacket surface region 132 in accordance with FIG. 7 as well as in the regions 145 of FIG. 8.

The channel structure 160 has a plurality of parallel-extending circumferential channels 162 as well as a transverse channel 164, which are respectively provided in the jacket surface 130. The circumferential channels 162 extend in the circumferential direction of the substrate web lifting device 120. The respective circumferential channels 162 are connected to one another via the transverse channel 164, with the transverse channel 164 intersecting the circumferential channels 162 centrally in the circumferential direction of the substrate web lifting device 120. A plurality of transverse channels could of course also be provided which intersect the circumferential channels 162 in the circumferential direction of the substrate web lifting device 120 at different points.

The circumferential channels 162 and the transverse channel 164 have the same depth, preferably in the range 0.1 to 1 mm. It is however also possible for the circumferential channels 162 and transverse channel 164 to have different depths. The circumferential channels 162 and transverse channel 164 can, for example, be provided in the jacket surface 130 in a suitable manner by means of laser treatment, etching or milling. The circumferential channels 162 and transverse channel 164 in the jacket surface 130 result in surface elements 170 lying between the circumferential channels 162.

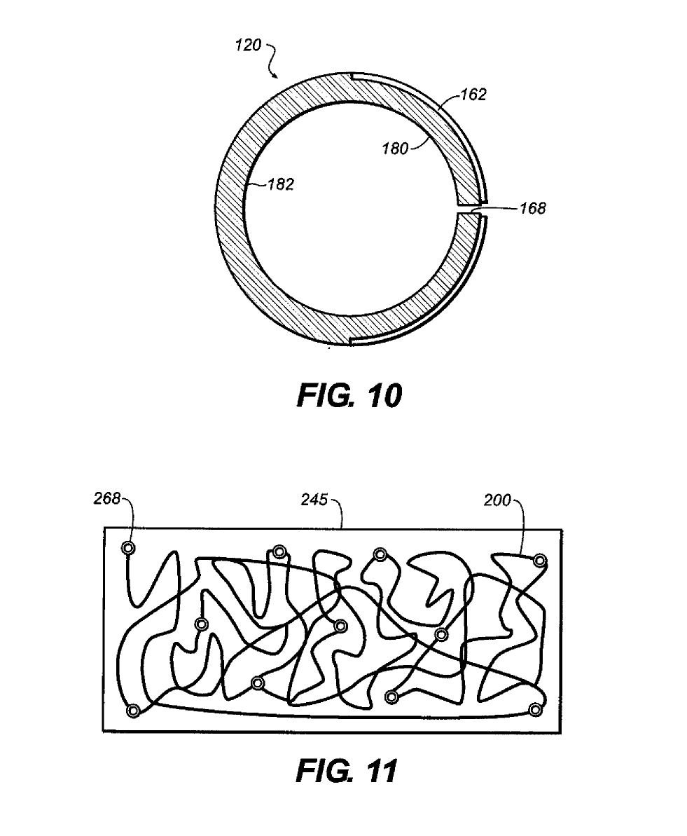

A gas outflow opening 168 in the form of a passage opening is provided in the region of the intersections of the circumferential channels 162 and the transverse channel 164, and connects the interior of the hollow pipe to the outer side, as can be readily seen in FIG. 10. The hollow pipe defines internally an interior 180 that is delimited in the radial direction by the inner wall 182. The gas outflow opening 168 extends here from the interior 180 into the transverse channel 164 in the jacket surface 130. The section along the line 10-10 from FIG. 9 shown in FIG. 10 furthermore shows one of the plurality of circumferential channels 162. It can be readily seen here that the circumferential channel extends over 180° in the circumferential direction of the substrate web lifting device 120, which in operation corresponds approximately to one encircling region of a substrate web 6.

The interior 180 first extends substantially over the entire length of the hollow pipe. The hollow pipe can be sealed at its ends in a suitable manner by end walls. At least one gas inflow opening is provided in the end walls and/or in a circumferential region outside the jacket surface 130 to supply the interior with gas, in particular compressed air. This inflow opening is not visible in this cross-section. The gas outflow openings 168 can here in turn be supplied with a gas flow.

The interior 180 can also be delimited by displaceable slide elements, not shown, in the longitudinal direction of the hollow pipe. This allows the interior to be changed and thus a selective application to gas outflow openings 168, for example to provide gas only where the substrate web 6, because of its defined width, encircles the substrate web lifting device 120. A selective application of this type also possible by, for example, corresponding subdivisions of the interior with individual gas application to the subdivisions, for example via valves. Direct gas lines could also be provided for the individual gas outflow openings 168 and can be supplied with gas, for example individually or grouped.

FIG. 11 shows a schematic detailed view of an alternative, continuous channel structure 200 in a jacket surface 130 of a substrate web lifting device 120 in accordance with a second aspect. The channel structure 200 can be formed in the region 245 correspondingly to that in the region 132 in accordance with FIG. 7 or to the regions 145 of FIG. 8.

FIG. 11 shows a statistical distribution of one or more channels of channel structure 200, with the following relating to only one channel. The channel is continuous, i.e. formed such that each point within the channel is connected to every other point in the channel via the channel.

The distribution of the channel forming the channel structure 200 inside the jacket surface corresponds to a statistical distribution. The distribution of the channel structure 200 substantially follows a uniform distribution, but can have any required distribution. The channel forming the channel structure 200 preferably has a depth of 0.1 to 1 mm.

Gas outflow openings 268 are again provided and open into the channel of the channel structure 200. The gas outflow openings 168 can also be statistically distributed in the substrate guide surface. The gas outflow openings 168 preferably have a diameter of 0.3 to 0.5 mm.

The functioning of the device is described in more detail below by reference to the drawings, in particular with reference to FIG. 1.

During in-feed of the substrate web 6, it is guided first from the feeder region 2 to the substrate web lifting device 20 and the printing region 3, and from there to the stacker region 4. For printing, the substrate web 6 is transported by a corresponding transport means through the printing press and in particular through the substrate web lifting device 20. An air cushion is formed at the substrate web lifting device 20 between the substrate web 6 and the jacket surface 35 of the substrate web lifting device during this transport. This can be achieved by a substrate web lifting device 20 that does not move or a substrate web lifting device 20 that is provided with drives and is rotated with an adequate speed, as a result of which an air cushion is generated. The substrate web lifting device 20 can here be driven either in the direction of movement of the substrate web 6 or counter to this direction.

The formation of the air cushion can be assisted, depending on the aspect of the substrate web lifting device 20, by corresponding means, such as the spiral groove 38 in the jacket surface 35 of the substrate web lifting device 20 in accordance with FIG. 3, the channel structure in FIGS. 7-11, and/or the use of a fan 60 in accordance with FIGS. 4-6. In the aspect with fan, air is sucked by the fans 60 into the pipe interior 48 of the substrate web lifting device 20 during rotation of the latter, and is expelled via the gas outflow openings 50. This assists the formation of the air cushion E (FIG. 1) between the jacket surface 35 of the substrate web lifting device 20 and the substrate web 6.

The air cushion E so generated can distribute itself uniformly over the entire jacket surface 35. The substrate web 6 is thereby transported along the printing units 10 at a controlled distance from them. Displacement of the fans 60 permits a selective activation of individual gas outflow openings 50 above the pipe interior 48. This enables the gas flow out of the substrate web lifting device 20 to be substantially adapted to a width of the substrate web 6.

The substrate web 6 is now printed by the printing units 10, with the distance between the substrate web 6 and the printing units 10 being kept constant during the printing process as described above. The lifting of the substrate web 6 by means of the air cushion E generated by the substrate web lifting device 20 results at the same time in an at least partial drying of the substrate web 6 during the printing process.

The invention has been described on the basis of concrete aspects, without being limited to these. In particular, it should be pointed out that the aspects can be freely combined with one another, and individual elements of the different aspects are interchangeable if required in so far as they are compatible. It will be also be understood that variations, combinations, and modifications can be effected by a person of ordinary skill in the art within the spirit and scope of the invention.

### PARTS LIST

1 printing press
2 feeder region
3 printing region
4 stacker region
5 substrate roll
6 substrate web
8 roll
10 printing unit
15 dryer
20 substrate web lifting device
35 jacket surface
37 groove structure
38 spiral groove
44 pipe body
48 pipe interior
50 gas flow opening
60 fan
65 wings
66 end opening
70 air baffle plate
72 air baffle plate main part
74 air baffle plate angled part
120 pipe-shaped substrate web lifting device
130 jacket surface
132 jacket surface region
145 region
146 region
160 continuous channel structure
162 parallel-extending circumferential channels
164 transverse channel
168 gas outflow opening
170 surface element
180 interior
182 interior wall
200 continuous channel
245 region
268 gas outflow opening
B movement direction
C direction arrow
D direction arrow
E air cushion

1. A device for printing a substrate web that is moved in a direction of transport past at least one printing unit, the device comprising a substrate web lifting device arranged opposite the at least one printing unit, the lifting device having:
a jacket surface opposite the printing unit; and
air cushion means forming an air cushion between the substrate web and the jacket surface of the substrate web lifting device, so that lifting of the substrate web is achieved.

2. The device according to claim 1, wherein the substrate web lifting device is arranged rotatably and the air cushion means is adapted, during a rotation of the substrate web lifting device, to promote the development of the air cushion between the jacket surface of the substrate web lifting device and the substrate web.

3. The device according to claim 2, wherein the air cushion means has at least one groove structure in the jacket surface.

4. The device according to claim 3, wherein the groove structure is a spiral groove structure.

5. The device according to claim 2, wherein the substrate web lifting device is a pipe having an interior and a plurality of gas outflow openings between the interior and the jacket surface, wherein the air cushion means in the interior includes at least one fan wheel rotatably connected to the pipe.

6. The device according to claim 5, wherein the air cushion means includes a radial compressor including the at least one fan wheel.

7. The device according to claim 5, wherein the air cushion means inside the pipe includes at least two fan wheels arranged on opposite ends of the pipe to bound the interior and blow air into the interior.

8. The device according to claim 5, further including at least one air baffle plate arranged adjacent to the substrate web lifting device so that a gas stream flowing out of the gas outflow openings is deflected to enter a region formed by the substrate web entering the substrate web lifting device and the jacket surface.

9. The device according to claim 5, further including at least one displacement unit for displacement of the at least one fan wheel inside the pipe.

10. The device according to claim 5, wherein the substrate web lifting device has a channel structure with a plurality of circumferential channels at a distance from one another and extending in the circumferential direction of the jacket surface, and at least one transverse channel extending transversely to the circumferential channels which is in flow connection to at least two circumferential channels, wherein at least one gas outflow opening opens into the channel structure.

11. The device according to claim 5, wherein the substrate web lifting device has a channel structure with a statistical distribution in the jacket surface.

12. The device according to claim 11, wherein the jacket surface includes a plurality of separate channel structure segments with a respective channel structure that are arranged adjacent to one another over a width of the jacket surface, and one respective channel structure is in flow connection to at least one of the gas outflow openings.

13. The device according to claim 5, further including two slide valves that are displaceable from opposite ends into the interior of the pipe, and a blower that blows air into the interior.

14. The device according to claim 5, further including a plurality of valves for individual or grouped application of gas to gas outflow openings.

15. A method for printing a substrate web that is moved in a direction of transport past at least one printing unit, the method comprising:
guiding the substrate web over a jacket surface of a substrate web lifting device arranged opposite the printing unit;
lifting a region of the substrate web in a printing region by developing an air cushion between the substrate web and the jacket surface of the substrate web lifting device; and
printing the lifted region of the substrate web.

16. The method according to claim 15, wherein the substrate web lifting device is a rotatably arranged pipe that has an interior, the pipe has passage openings from the interior to the jacket surface, and the lifting step includes rotating the substrate web lifting device so that air is sucked in via the interior and is expelled through gas outflow openings in the jacket surface.

17. The method according to claim 16, further including selectively applying air to the gas outflow openings in the pipe.
